(19) United States
(12) Patent Application Publication
(10) Pub. No.: US 2008/0231816 A1
(43) Pub. Date: Sep. 25, 2008

(54) DISCHARGE LAMP LIGHTING DEVICE AND IMAGE PROJECTION DEVICE

(75) Inventor: Takaaki TANAKA, Imabari-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: HARRISON TOSHIBA LIGHTING CORP., Imabari-shi (JP)

(21) Appl. No.: 12/053,032

(22) Filed: Mar. 21, 2008

(30) Foreign Application Priority Data
Mar. 23, 2007 (JP) P2007-076959

(51) Int. Cl. G03B 21/14; H05B 41/24

(52) U.S. Cl. 353/85; 315/287

(57) ABSTRACT

To provide a discharge lamp lighting device which is made efficient at the time of starting to light a high-voltage discharge lamp and has quick illumination rising. To start a high-voltage discharge lamp 17 by a pulse high-voltage, the high-voltage discharge lamp 17 is controlled to have the rated power or more by duty output which is previously recorded in a control circuit 18 according to a voltage detection signal (d) and a current detection signal (e) of the lamp. For the electric power control of the control circuit 18, the rated power or more is temporarily supplied to the lamp in several tens of seconds from the start of the lamp, and then the electric power is moderately lowered to the rated power. Thus, the electric power at the time of starting to light is made efficient, and it becomes possible to make the illumination rising quick.

### CROSS-REFERENCE TO RELATED APPLICATIONS

This application is based upon and claims the benefit of priority from the prior Japanese Patent Application No. 2007-076959 filed on Mar. 23, 2007; the entire contents of which are incorporated herein by reference.

### BACKGROUND

1. Field of the Invention

The present invention relates to a discharge lamp lighting device which starts a high-voltage discharge lamp such as a metal halide lamp with a pulse high-voltage and to an image projection device using the same.

2. Description of the Related Art

Conventionally, in a case where a mercury-free high-voltage discharge lamp is started at a low temperature, a real supply lamp power is adjusted along a target supply lamp power of the high-voltage discharge lamp to accelerate rising of flux of light and to perform stable lighting in a short time by properly controlling the lamp power (e.g., JP-A 2006-73537 (KOKAI)).

### SUMMARY

The technology of the above-described JP-A 2006-73537 (KOKAI) is directed to a lamp having low rated power such as HID for vehicle headlights. A lamp having high rated power such as a projector has a disadvantage that when a high electric power is applied from a state that the lamp just started has a low voltage, a large lamp current flows and the efficiency at the time of starting to light is degraded.

According to an aspect of the present invention, there is provided a discharge lamp lighting device which is made efficient at the time of starting to light and has quick illumination rising and an image projection device using the same.

To remedy the above-described problems, the present invention provides a discharge lamp lighting device, comprising a DC/DC converter which converts an input DC voltage into a desired DC voltage and outputs it; a DC/AC inverter which converts the DC voltage into AC power and applies it to a high-voltage discharge lamp; a lamp start circuit which applies a pulse high-voltage to the discharge lamp at the time of starting the discharge lamp; and a control circuit which detects a lamp voltage and lamp current of the discharge lamp and performs lighting control of the discharge lamp according to the detection signals, wherein rated power or more is temporarily supplied to the discharge lamp in a prescribed time after the start of the discharge lamp, and the electric power is moderately reduced to the rated power after a lapse of a prescribed time.

### BRIEF DESCRIPTION OF THE DRAWINGS

FIG. 1 is a circuit diagram for illustrating an embodiment of a discharge lamp lighting device of the present invention.

FIG. 2 is an explanatory diagram for illustrating an operation of FIG. 1.

FIG. 3 is an explanatory diagram for illustrating lighting control of a high-voltage discharge lamp according to the present invention.

FIG. 4 is an explanatory diagram for illustrating an effect of the present invention.

FIG. 5 is a flow chart for illustrating another embodiment of the discharge lamp lighting device according to the present invention.

FIG. 6 is a structure diagram for illustrating an embodiment of an image projection device according to the present invention.

### DETAILED DESCRIPTION

The best modes of the present invention will be described in detail with reference to the drawings.

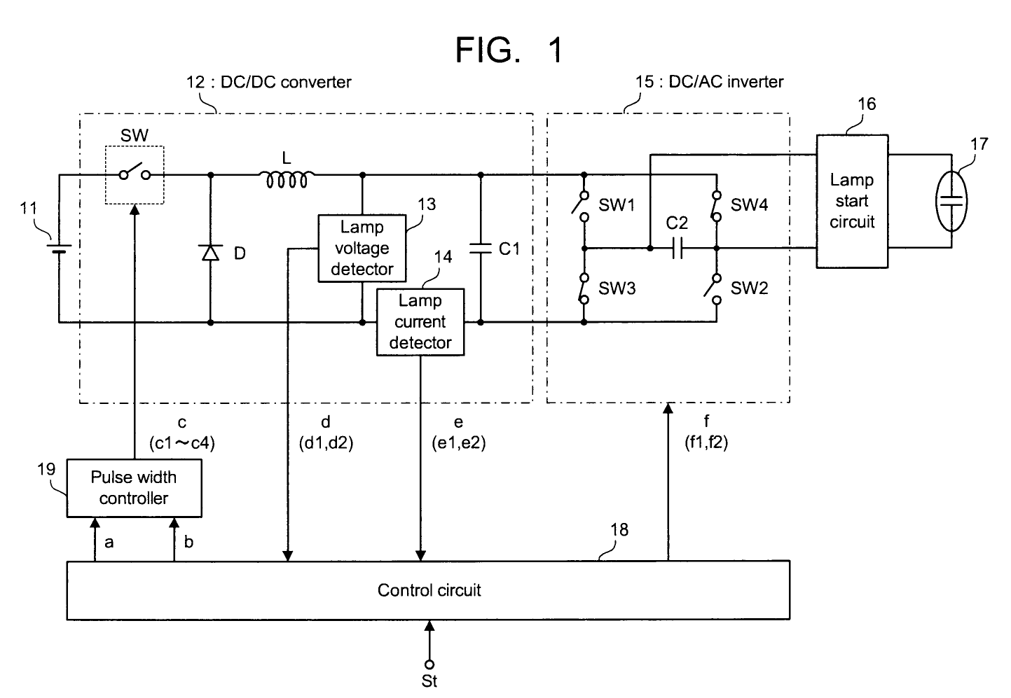

FIG. 1 is a circuit block diagram for illustrating an embodiment of a discharge lamp lighting device according to the present invention.

In FIG. 1, 11 denotes a DC power source, and this power source 11 supplies power to a DC/DC converter 12 which lowers a DC voltage of the power source 11. In the DC/DC converter 12, the positive electrode of the power source 11 is connected to one end of a choke coil L and the cathode of a diode D whose anode is grounded via a switch element SW based on, for example, a MOS type FET transistor. The other end of the coil L is grounded via a smoothing capacitor C1 and also grounded via a lamp voltage detector 13. A lamp current detector 14 is interposed between the ground side of the lamp voltage detector 13 and the ground side of the capacitor C1.

Output of the DC/DC converter 12 is connected to full bridge switch elements SW1, SW4 which are used in combination from switch elements SW1 to SW4 based on, for example, the MOS type FET transistor, which configure a DC/AC inverter 15 for converting a DC voltage output from the DC/DC converter 12 into AC power. The switch element SW1 is grounded via the switch element SW3, and the switch element SW4 is grounded via the switch element SW2. A capacitor C2 for formation of an oscillatory waveform and current limitation is interposed between a connection point between the switch elements SW1 and SW3 and a connection point between the switch elements SW3 and SW2. The switch elements SW1 and SW2 are simultaneously turned on and off, and the switch elements SW3 and SW4 are also simultaneously turned on or off, but they are conversely turned on or off by a polarity inversion signal.

Both ends of the capacitor C2 are connected to a lamp start circuit 16 which generates a pulse high-voltage when the lamp is turned on, and output of the lamp start circuit 16 is supplied to a high-voltage discharge lamp 17.

Numeral 18 denotes a control circuit, and the control circuit 18 receives a start signal which is supplied to a start signal supply terminal St and outputs a control signal (a) for turning on and off a pulse width controller 19 and a duty control signal (b) which controls the duty of the pulse width controller 19.

The pulse width controller 19 outputs an output pulse (c) which drives the DC/DC converter 12 by the duty based on the duty control signal (b). The control circuit 18 is supplied with a voltage detection signal (d) of the lamp voltage detector 13 and a current detection signal (e) of the lamp current detector 14 of the DC/DC converter 12.

Besides, the control circuit 18 alternately turns on and off the switch elements SW1, SW2 and the switch elements SW3, SW4 of the DC/AC inverter 15 to output a drive pulse signal (f) for obtaining an AC voltage from the output of the DC/AC inverter 15.

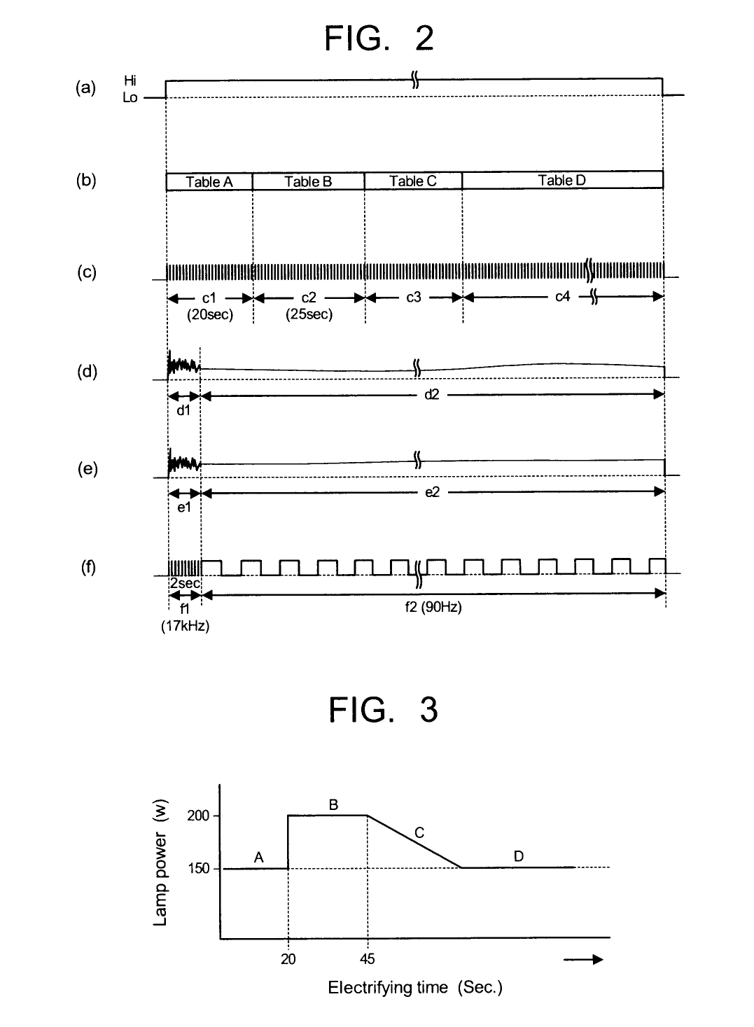

An operation of FIG. 1 is described below with reference to the timing chart of FIG. 2 and the waveform diagram of FIG. 3 for illustrating a lamp power at the time of starting.

First, the control circuit 18, which has a start signal supplied to the start signal terminal St to turn on the high-voltage discharge lamp 17, supplies the control signal (a) shown (a) in FIG. 2 to the pulse width controller 19 to perform ON control and also supplies the duty control signal (b) shown (b) in FIG. 2 for controlling the duty of a signal output from the pulse width controller 19. The duty control signal (b) is generated based on drive information of the high-voltage discharge lamp 17 and information of tables A to D which are previously stored in the control circuit 18.

As shown (c) in FIG. 2, the pulse width controller 19 generates at the starting time the output pulse (c) of different duties c1 to c4 based on the control signal (b) having a duty variable with a lapse of time and supplies the output pulse (c) to the switch element SW of the DC/DC converter 12.

The DC/DC converter 12 turns on or off the switch element SW according to the output pulse (c) to perform switching of the DC voltage of the power source 11, converts the switching output to the DC voltage and outputs it. The DC voltage causes the on/off control of the switch elements SW1 to SW4 of the DC/AC inverter 15 by a drive pulse signal f1 which is output from the control circuit 18 as shown (f) in FIG. 2. For example, the switch elements SW1, SW2 are turned on when a drive pulse signal d1 is at a Hi level and off when it is at a Lo level, and the switch elements SW3, SW4 are turned on when the drive pulse signal d1 is at a Lo level and off when it is at a Hi level. A drive pulse signal f2 is selected to have a frequency value lower than that of the DC/DC converter 12.

The drive pulse signal f1 at the time of starting to light and preheating drives the switch elements SW1 to SW4 at a relatively high frequency of, for example, about 17 kHz for about two seconds, and the drive pulse signal f2 at the time of normal lighting drives the switch elements SW1 to SW4 at a relatively low frequency of, for example, about 90 Hz.

The switch elements SW1, SW2 and the switch elements SW3, SW4 are alternately turned on and off by a high-frequency drive pulse f1, during which a pulse high-voltage is supplied from the lamp start circuit 16 to the high-voltage discharge lamp 17. The high-voltage discharge lamp 17 has the insulation between the electrodes configuring the high-voltage discharge lamp 17 broken by the pulse high-voltage and starts to light.

When the high-voltage discharge lamp 17 is lit, the voltage detection signal d1 exhibits a voltage with noise superimposed on it in a period d1 when the DC/AC inverter 15 is driven by the drive pulse signal f1 at a frequency of 17 kHz as shown (d) in FIG. 2, but a noise-free voltage is obtained in a period d2 when driving at a frequency of 90 Hz. And, the current detection signal (e) exhibits a current with noise superimposed on it in a period e1 when the DC/AC inverter 15 is driven by the drive pulse signal f1 at a frequency of 17 kHz as shown (e) in FIG. 2, but a noise-free current is obtained in a period e2 when driving at a frequency of 90 Hz.

A voltage detection signal d2 detected by the lamp voltage detector 13 and a current detection signal e2 detected by the lamp current detector 14 are supplied to the control circuit 18, and according to these voltage and current detection signals and the previously stored tables, the lamp power which is output from the DC/DC converter 12 is determined.

It is described below that the control circuit 18 generates an output pulse (c) according to the voltage and current detection signals and the control information written into the tables A to D to determine the lamp power.

First, the control circuit 18 outputs the output pulse cl of the duty according to the voltage detection signals d1, d2, the current detection signals e1, e2 and the contents of Table A for, for example, 20 seconds from the start. The DC/DC converter 12 generates the lamp power determined by the output pulse c1, for example, a rated power of 150 W as shown A in FIG. 3.

Then, the control circuit 18 outputs an output pulse c2 of the duty according to the voltage detection signal d2, the current detection signal e2 and the contents of Table B. The DC/DC converter 12 generates the lamp power determined by the output pulse c2, for example, 200 W as shown B in FIG. 3. The generation time of the output pulse c2 is determined to be, for example, 25 seconds.

After the generation of the output pulse c2, the control circuit 18 outputs an output pulse c3 of the duty based on the voltage detection signal d2, the current detection signal e2 and the contents of the table C. The output pulse c3 has the contents of the duty to gradually reduce the lamp power to the rated power. Therefore, the lamp power is gradually lowered to the rated power of 150 W as shown C in FIG. 3.

At the time when the lamp power becomes the rated power of 150 W based on the output pulse c3, the control circuit 18 outputs an output pulse c4 of the duty based on the voltage detection signal d2, the current detection signal e2 and the contents of the table D. The DC/DC converter 12 generates the lamp power determined by the output pulse c4, namely the rated power of 150 W as shown D in FIG. 3. Subsequently, it is controlled to maintain the lamp power of the above state.

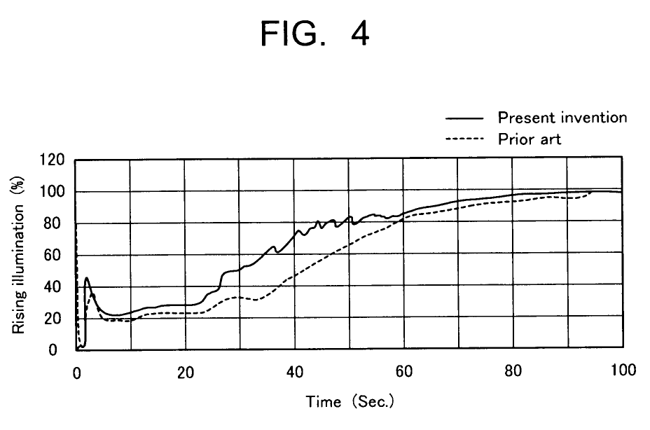

FIG. 4 is a characteristic diagram for illustrating a relationship between the electric power control described with reference to FIG. 3 and the illumination rising of the high-voltage discharge lamp.

FIG. 4 shows the illumination rising of a case of performing the electric power control of FIG. 3 to generate the lamp power by the voltage detection signal and the current detection signal and the duty which is previously determined according to these detection signals with a lapse of start time and a case of prior art that simply determines the lamp power based on the voltage detection signal and the current detection signal.

As shown in FIG. 4, the illumination conventionally took about 41 seconds to reach 50% of the rated value, but the present invention can reduce it to about 28 seconds. And, the illumination conventionally took about 59 seconds to reach 80% of the rated value, but the present invention can reduce it to about 44 seconds.

Thus, the rated power or more is temporarily supplied to the lamp in several tens of seconds from the start of the lamp, then the electric power is moderately lowered to the rated power. Thus, a stress applied to the lighting circuit at the time of starting to light is reduced, and the illumination rising characteristics can be improved.

In the above-described embodiment, the rated power of the high-voltage discharge lamp 17 is determined to be 150 W but not limited to it. And, a time for having the rated power operation after the start was determined to be 20 seconds as an example, but it may be in a range of 15 seconds to 30 seconds. The temporal rated power or more after the lapse of prescribed time from the start was determined to be in a range of 150 W to 200 W as an example but may be in a range of 1.5 times to 2.0 times. Besides, the time for temporarily increasing the rated power was determined to be 25 seconds as an example but may be in a range of 20 seconds to 30 seconds.

Besides, the above-described embodiment inputs the voltage detection signal (e) and the current detection signal (f) of the high-voltage discharge lamp 17, but they are same as information for detecting the state of the high-voltage discharge lamp 17, so that the use of one of them is sufficient. And, the switch elements SW1 to SW4 configuring the DC/AC inverter 15 are determined to be a full bridge type, but a half bridge structure using two switch elements can provide a similar means to suppress noise due to the pulse high-voltage and to prevent a malfunction of the control circuit.

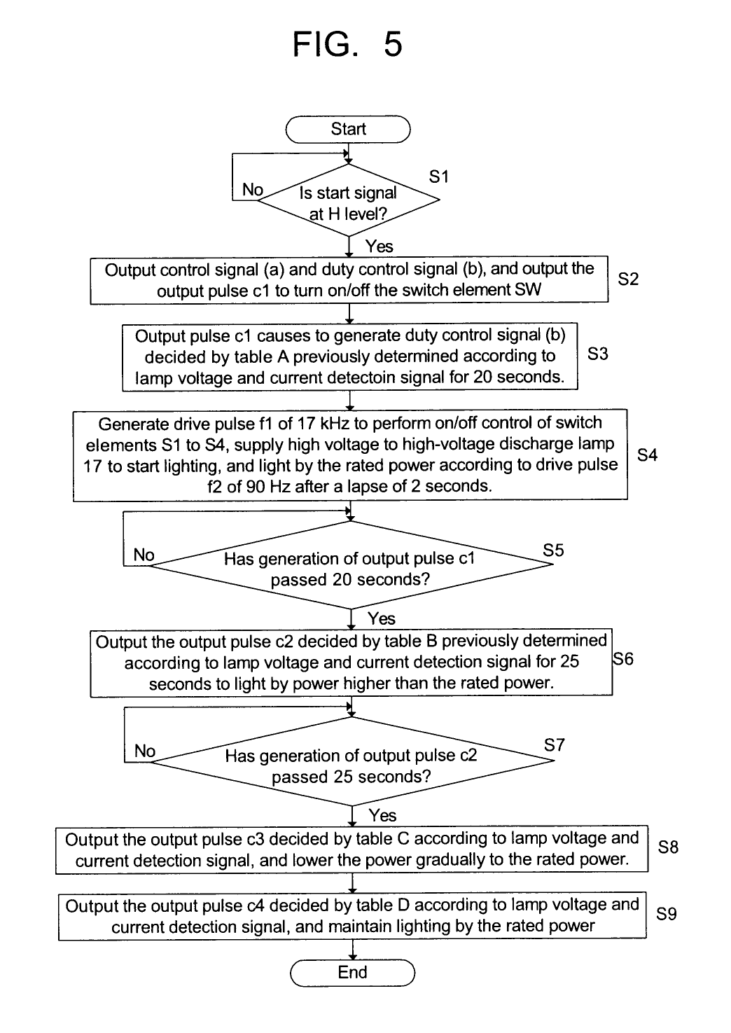

FIG. 5 is a flow chart for illustrating another embodiment of the discharge lamp lighting device according to the present invention. This embodiment can also be realized by processing of a microcomputer program by the control circuit 18. FIG. 5 is described below with reference to FIG. 1 to FIG. 3.

First, the control circuit 18 judges whether a lighting start signal has been supplied to a start signal supply terminal st (S1) and, if the start signal is at a Hi level, causes to output a control signal (a) and a duty control signal (b) to turn on the pulse width controller 19 (S2).

At this time, the duty control signal (b) supplied from the control circuit 18 to the pulse width controller 19 is in accordance with the table A for generating the rated power according to the voltage control signal (d) and the current detection signal (e) and outputs the output pulse c1 which is based on the duty control signal for, for example, 20 seconds (S3).

During the above period, the control circuit 18 generates a drive signal f1 of 17 kHz for driving the switch elements SW1 to SW4 of the DC/AC inverter 15 for two seconds (S4) to alternately turn on the switch elements SW1, SW2 and the switch elements SW3, SW4 so as to supply a pulse high-voltage from the lamp start circuit 16 to the high-voltage discharge lamp 17. The high-voltage discharge lamp 17 causes to break the insulation by the pulse high-voltage to start lighting. After a lapse of two seconds, the DC/AC inverter 15 is driven by a drive signal f2 of 90 Hz to continue the normal lighting of the high-voltage discharge lamp 17 by a low voltage.

The control circuit 18 judges whether it has passed 20 seconds from the start (S5). After a lapse of 20 seconds, the control circuit 18 generates the duty control signal (b) by the table B which temporarily increases the rated power to 200 W based on the voltage detection signal (d) and the current detection signal (e) and outputs the output pulse c2 according to the duty control signal for, for example, 25 seconds (S6).

After a lapse of 25 seconds for the generation of the pulse c2 (S7), the duty control signal (b) is generated by the table C which gradually lowers the electric power of 200 W to the rated power of 150 W according to the voltage detection signal (d) and the current detection signal (e), and the electric power control shown C in FIG. 3 is performed by the output pulse c3 according to the duty control signal (S8).

When the lamp power becomes the rated power of 150 W, the control circuit 18 generates the duty control signal (b) by the table D which maintains the rated power according to the voltage detection signal (d) and the current detection signal (e), and lighting by the rated power is maintained as shown D in FIG. 3 by the output pulse c4 according to this duty control signal (S9).

Thus, even when the control circuit 18 is processed by the microcomputer, the rated power or more is temporarily supplied to the lamp after a lapse of several tens of seconds from the start of the lamp, and then, the power is moderately lowered to the rated power. Thus, a stress to the lighting circuit at the time of starting to light is reduced, and the illumination rising characteristics can be improved.

In the hardware structure of the embodiment of performing the processing by the microcomputer, either one may be input as information for detecting a lit state of the high-voltage discharge lamp 17. And, the switch elements SW1 to SW4 configuring the DC/AC inverter 15 are determined to be a full bridge type but may be a half bridge type using two switch elements.

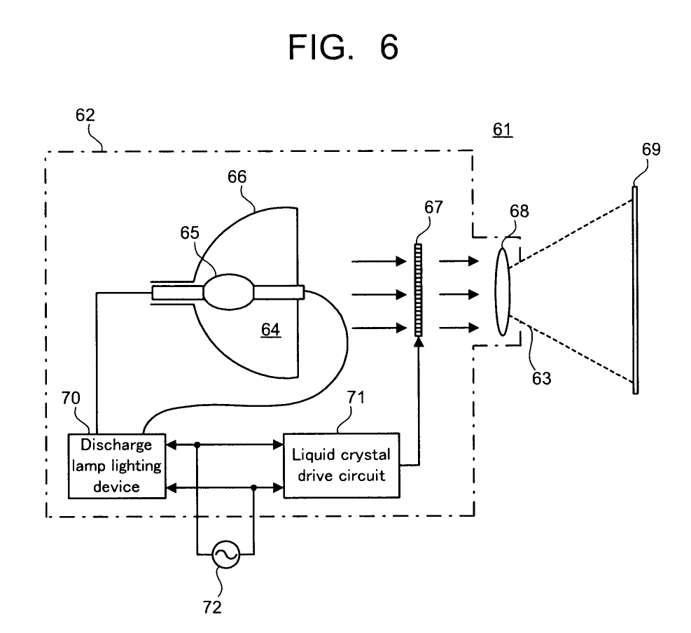

FIG. 6 is a configuration diagram for illustrating an embodiment of an image projection device using the discharge lamp lighting device of the present invention.

In FIG. 6, 61 denotes one type of liquid crystal projector as the image projection device. This liquid crystal projector 61 has a body 62, and a projection opening 63 is formed at the front of the body 62. A light source 64 is disposed in the body 62, and the light source 64 is comprised of a high-voltage discharge lamp 65 and a reflector 66 as a reflection means which is optically opposed to the high-voltage discharge lamp 65. And, a liquid crystal panel 67 is disposed as a display means at the front of an irradiation direction from the light source 64, and a projection lens 68 is disposed as a projection means in correspondence with the projection opening 63 in front of the liquid crystal panel 67. A screen 69 is disposed in front of the projection opening 63.

Besides, a discharge lamp lighting device 70 is connected to the high-voltage discharge lamp 65, a liquid crystal drive circuit 71 is connected to the liquid crystal panel 67, and a commercial AC power source 72 is connected to the discharge lamp lighting device 70 and the liquid crystal drive circuit 71. The discharge lamp lighting device 70 may turn on the high-voltage discharge lamp 65 by direct current or alternating current.

First, the above-configured image projection device turns on the high-voltage discharge lamp 65 of the light source 64 by the electric power supplied from the discharge lamp lighting device 70 described with reference to FIG. 1. The light from the high-voltage discharge lamp 65 is irradiated in the direction of the liquid crystal panel 67 directly or reflexively from the reflector 66. The liquid crystal panel 67 changes the display by the liquid crystal drive circuit 71, allows the light from the light source 64 to pass through to project by the projection lens 68 and shows an image on the screen 69.

The reflector 66 is open in a radiation direction but may have a transparent front glass arranged to seal the high-voltage discharge lamp 65, which is disposed in the reflector 66, from the outside.

In this embodiment, even a high-voltage discharge lamp for a liquid crystal projector having a high rated power can improve lighting efficiency at the time of starting to light.

According to the present invention, the rated power or more is temporarily supplied to the lamp after a lapse of several tens of seconds from the start of the lamp, then the electric power is moderately lowered to the rated power. Thus, a stress applied to the lighting circuit at the time of starting to light is reduced, and the illumination rising characteristic can be improved.

What is claimed is:

1. A discharge lamp lighting device, comprising:
a DC/DC converter which converts an input DC voltage into a desired DC voltage and outputs it;
a DC/AC inverter which converts the DC voltage into AC power and applies it to a high-voltage discharge lamp;
a lamp start circuit which applies a pulse high-voltage to the discharge lamp at the time of starting the discharge lamp; and
a control circuit which detects a lamp voltage and lamp current of the discharge lamp and performs lighting control of the discharge lamp according to the detection signals,
wherein rated power or more is temporarily supplied to the discharge lamp in a prescribed time after the start of the discharge lamp, and the electric power is moderately reduced to the rated power after a lapse of a prescribed time.

2. The discharge lamp lighting device according to claim 1, wherein an initial lighting operation is performed for 15 to 30 seconds after the starting of the high-voltage discharge lamp, electric power 1.5 to 2.0 times larger than the rated power is then supplied, and the electric power is gradually lowered to the original rated power over 20 to 30 seconds.

3. An image projection device, comprising:
the discharge lamp lighting device according to claim 1 which turns on the a high-voltage discharge lamp; and
an image projection device body which has the high-voltage discharge lamp as a light source and projects an image based on light emitted from the light source.
